(19) United States
(12) Patent Application Publication
(10) Pub. No.: US 2016/0014689 A1
(43) Pub. Date: Jan. 14, 2016

(54) ADVERTISING SUPPORTED DOMAINS VIA PROBE REQUEST/RESPONSE AND BEACONS

(71) Applicant: QUALCOMM Incorporated, San Diego, CA (US)

(72) Inventors: Jouni Kalevi MALINEN, Tuusula (FI); Abhishek Pramod PATIL, San Diego, CA (US); George CHERIAN, San Diego, CA (US)

(21) Appl. No.: 14/798,409

(22) Filed: Jul. 13, 2015

Related U.S. Application Data
(60) Provisional application No. 62/024,459, filed on Jul. 14, 2014.

(51) Int. Cl. H04W 48/20; H04W 48/16

(52) U.S. Cl. CPC H04W 48/20; H04W 48/16

(57) ABSTRACT

In an aspect of the disclosure, a method, a computer-readable medium, and an apparatus are provided. The apparatus may be a station. The station receives a first beacon frame from an access point. The first beacon frame includes a first indication of a first set of domains that are supported by the access point. The station determines that the station has not established credentials with any one domain of the first set of domains. The station may receive a second beacon frame from the access point. The second beacon frame includes a second indication of a second set of domains that are supported by the access point. The first set of domains is different from the second set of domains. The station may send, to the access point, a probe request frame including a third indication of a third set of domains with which the station has established second credentials.

### CROSS-REFERENCE TO RELATED APPLICATION(S)

This application claims the benefit of U.S. Provisional Application Ser. No. 62/024,459, entitled “ADVERTISING SUPPORTED DOMAINS VIA PROBE REQUEST/RESPONSE AND BEACONS” and filed on Jul. 14, 2014, which is expressly incorporated by reference herein in its entirety.

### BACKGROUND

1. Field

The present disclosure relates generally to communication systems, and more particularly, to techniques of a wireless device for advertising supported domains via probe request/response and beacons.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

An access point (AP) may support several domains. There is a need, especially with dense deployment of APs, for providing information indicating the supported domains to stations (STAs).

### SUMMARY

The systems, methods, computer program products, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

In an aspect of the disclosure, a method, a computer-readable medium, and an apparatus are provided. The apparatus may be a station. The station receives a first beacon frame from an access point. The first beacon frame includes a first indication of a first set of domains that are supported by the access point. The station determines that the station has not established credentials with any one domain of the first set of domains. The station may receive a second beacon frame from the access point. The second beacon frame includes a second indication of a second set of domains that are supported by the access point. The first set of domains is different from the second set of domains. The station may send, to the access point, a probe request frame including a third indication of a third set of domains with which the station has established second credentials.

In another aspect of the disclosure, a method, a computer-readable medium, and an apparatus are provided. The apparatus may be an access point. The access point determines a first subset of domains of a plurality of domains in accordance with a predetermined rule. Each of the plurality of domains is associated with a service provider. The predetermined rule defines that the first subset of domains is selected in accordance with a usage of each of the plurality of domains by stations. Alternatively, the predetermined rule defines that a selected subset of domains is different from each subset in one or more consecutive, previously selected subsets until each of the plurality of domains has been included at least once in the one or more consecutive, previously selected subsets. The access point transmits a first indication of the first subset of domains in an information element in a beacon frame.

In yet another aspect of the disclosure, a method, a computer-readable medium, and an apparatus are provided. The apparatus may be an access point. The access point receives, from a station, a probe request frame including a first indication of a first set of domains with which the station has established credentials. The access point determines whether a second set of domains is supported by the access point. The second set of domains is a subset of the first set of domains. The access point sends a second indication of the second set of domains to the station in a first probe response frame when the second set of domains is determined to be supported by the access point. In certain configurations, the first indication is included in a fast initial link setup (FILS) request parameters element of the probe request frame. The second indication is included in a FILS indication information element (IE) of the first probe response frame. In certain configurations, the access point sends, to the station, an indication of a plurality of domains supported by the access point in a second probe response frame or ignoring the probe request frame, when none of the first set of domains is determined to be supported by the access point. In certain configurations, the indication of each given domain of the plurality of domains, the first set of domains, and the second set of domains is a hash of a name of the given domain or a full name of the given domain.

### BRIEF DESCRIPTION OF THE DRAWINGS

FIG. 1 shows an example wireless communication system in which aspects of the present disclosure may be employed.

FIG. 2 is a diagram illustrating an authentication process of devices in a wireless network (e.g., a Wi-Fi network).

FIG. 3 is a diagram illustrating a beacon frame.

FIG. 4 is a diagram illustrating a probe request frame and a probe response frame.

FIG. 5 is a flow chart of a method (process) for selecting an access point for connection.

FIG. 6 is a flow chart of a method (process) for selecting an access point for connection based on a probe response frame.

FIG. 7 is a flow chart of a method (process) for not selecting an access point for connection based on lack of a response from the access point.

FIG. 8 is a flow chart of a method (process) for not selecting an access point for connection based on a probe response frame.

FIG. 9 is a flow chart of a method (process) for advertising supported domains via a beacon frame.

FIG. 10 is a flow chart of a method (process) for advertising supported domains via a probe response frame.

FIG. 11 is a functional block diagram of an example wireless device.

FIG. 12 is a diagram illustrating an example of a hardware implementation of a wireless device.

### DETAILED DESCRIPTION

Various aspects of the novel systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, wireless signals may be transmitted according to an Institute of Electrical and Electronics Engineers (IEEE) 802.11 protocol using orthogonal frequency-division multiplexing (OFDM), direct-sequence spread spectrum (DSSS) communications, a combination of OFDM and DSSS communications, or other schemes. Implementations of the IEEE 802.11 protocol may be used for sensors, metering, and smart grid networks. Advantageously, aspects of certain devices implementing the IEEE 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a WiFi (e.g., IEEE 802.11 protocol) compliant wireless link to obtain general connectivity to the Internet or to other wide area networks. In some implementations, a STA may also be used as an AP.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, an access terminal may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatus may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the IEEE 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

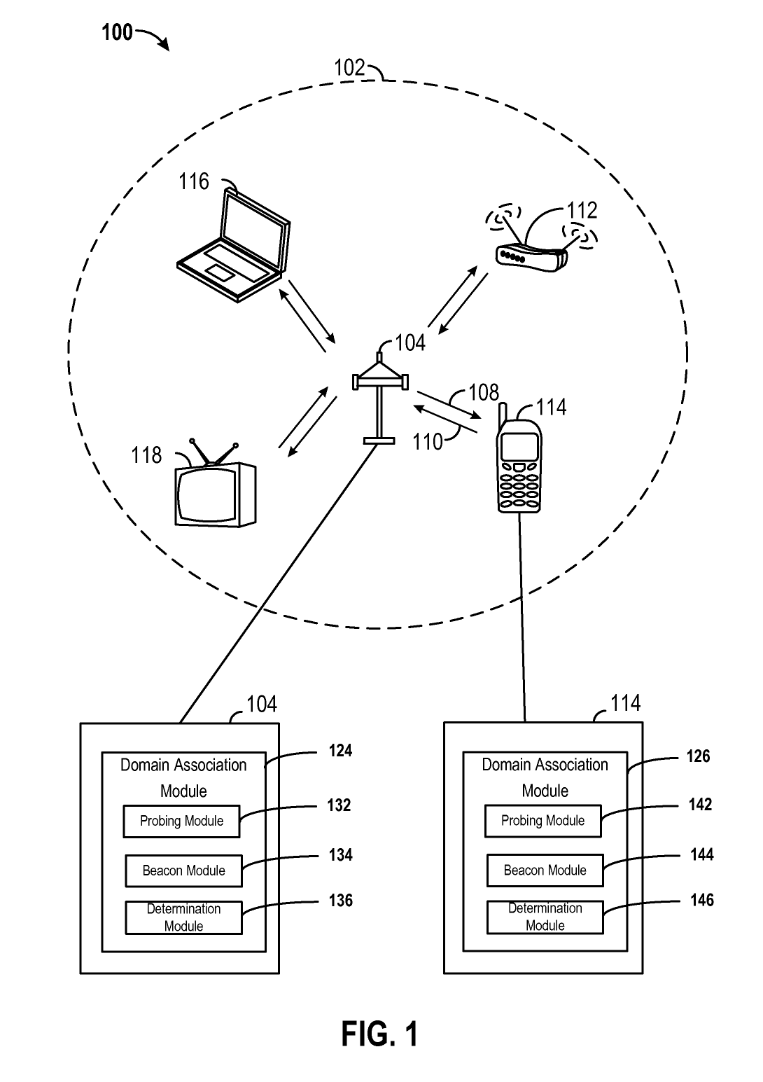

FIG. 1 shows an example wireless communication system 100 in which aspects of the present disclosure may be employed. The wireless communication system 100 may operate pursuant to a wireless standard, for example the IEEE 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

The AP 104 may include one or more modules for performing various functions. For example, the AP 104 may include a domain association module/circuitry 124. The domain association module/circuitry 124 may include a probing module/circuitry 132, a beacon module/circuitry 134, and a determination module/circuitry 136. The beacon module/circuitry 134 may control a process of receiving a first beacon frame from the AP 104. The first beacon frame includes a first indication of a first set of domains that are supported by the AP 104. The determination module/circuitry 136 may control a process of determining that the station has not established credentials with any one domain of the first set of domains. In certain configurations, the beacon module/circuitry 134 may control a process of receiving a second beacon frame from the AP 104. The second beacon frame includes a second indication of a second set of domains that are supported by the AP 104. The first set of domains is different from the second set of domains. In certain configurations, the probing module/circuitry 132 may control a process of sending, to the AP 104, a probe request frame including a third indication of a third set of domains with which the station has established second credentials.

The STA 114 may include one or more modules for performing various functions. For example, the STA 114 may include a domain association module/circuitry 126. The domain association module/circuitry 126 may include a probing module/circuitry 142, a beacon module/circuitry 144, and a determination module/circuitry 146. In certain configurations, the determination module/circuitry 146 may control a process of determining a first subset of domains of a plurality of domains in accordance with a predetermined rule. Each of the plurality of domains is associated with a service provider. The predetermined rule defines that the first subset of domains is selected in accordance with a usage of each of the plurality of domains by stations. Alternatively, the predetermined rule defines that a selected subset of domains is different from each subset in one or more consecutive, previously selected subsets until each of the plurality of domains has been included at least once in the one or more consecutive, previously selected subsets. The beacon module/circuitry 144 may control a process of transmitting a first indication of the first subset of domains in an information element in a beacon frame.

In certain configurations, the probing module/circuitry 142 may control a process of receiving, from a station, a probe request frame including a first indication of a first set of domains with which the station has established credentials. The determination module/circuitry 146 may control a process of determining whether a second set of domains is supported by the access point. The second set of domains is a subset of the first set of domains. The probing module/circuitry 142 may control a process of sending a second indication of the second set of domains to the station in a first probe response frame when the second set of domains is determined to be supported by the access point.

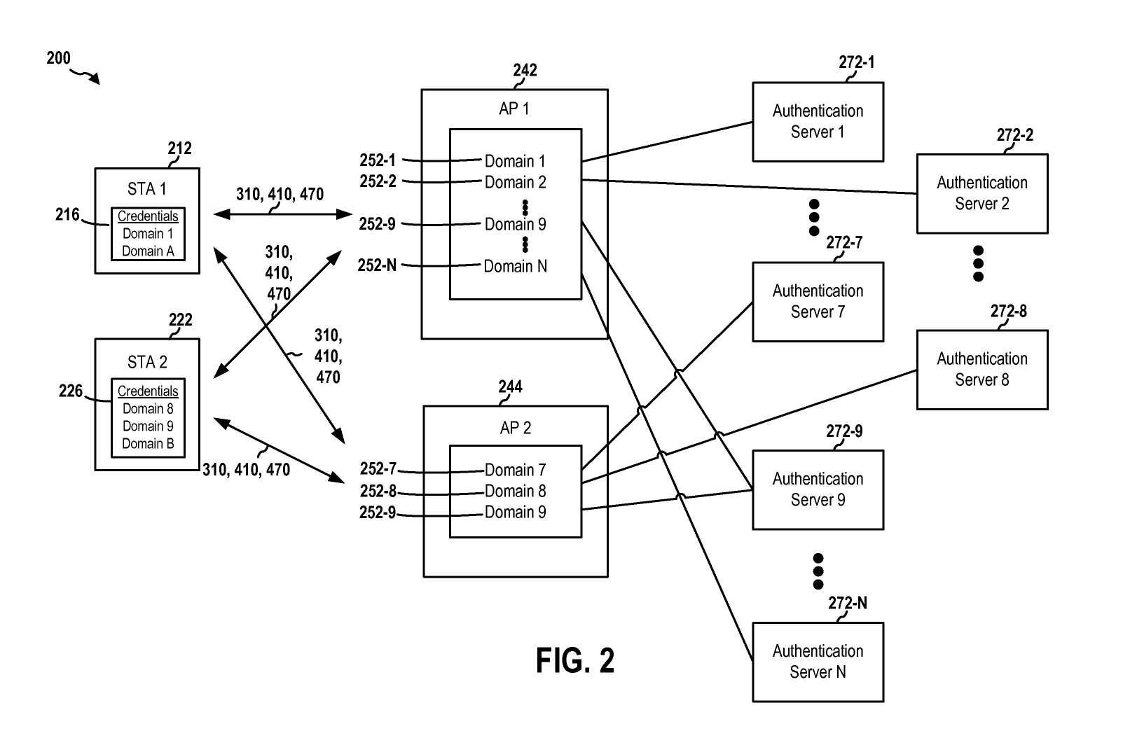

FIG. 2 is a diagram 200 illustrating an authentication process of devices in a wireless network (e.g., a Wi-Fi network). A 1^{st} STA 212 and a 2^{nd} STA 222 may seek association with a 1^{st} AP 242 and a 2^{nd} AP 244. In this example, the 1^{st} AP 242 supports N domains 252-1, . . . , 252-N provided by N service providers, respectively. The 2^{nd} AP 244 only supports the 7^{th} domain 252-7, the 8^{th} domain 252-8, and the 9^{th} domain 252-9 of the N domains 252-1, . . . , 252-N.

More specifically, the 1^{st} AP 242 may be configured to provide, to other STAs, access to WLAN services of the N service providers. The 1^{st} service provider, the 2^{nd} service provider, . . . , and the N^{th} service provider may configure the 1^{st} domain 252-1, the 2^{nd} domain 252-2, . . . , and the N^{th} domain 252-N at the 1^{st} AP 242 and provide, to the 1^{st} AP 242, the 1^{st} authentication server 272-1, the 2^{nd} authentication server 272-2, . . . , and the N^{th} authentication server 272-N for authenticating STAs seeking association, respectively. That is, the 1^{st} AP 242 can authenticate a STA through one or more of the 1^{st} authentication server 272-1, the 2^{nd} authentication server 272-2, . . . , and the N^{th} authentication server 272-N in accordance with the domains utilized by the STA. The 2^{nd} AP 244 may be configured similarly to support the 7^{th} domain 252-7, the 8^{th} domain 252-8, and the 9^{th} domain 252-9.

Further, the APs 242, 244 may support fast initial link setup (FILS) procedures. In certain configurations, FILS procedures allow faster connection to the network by performing authentication, association, and key confirmation using fewer frames (e.g., 4 frames including 2 authentication frames, an association request frame, and an association response frame).

The STAs 212, 222 each may have established credentials with one or more of the N domains 252-1, . . . , 252-N that enable the STAs 212, 222 to seek association with APs supporting those domains through FILS procedures. Thus, the STAs 212, 222 may prefer to be associated with the APs supporting the domains with which the STAs 212, 222 has established credentials. The credentials may include a user name, a password, and/or a key.

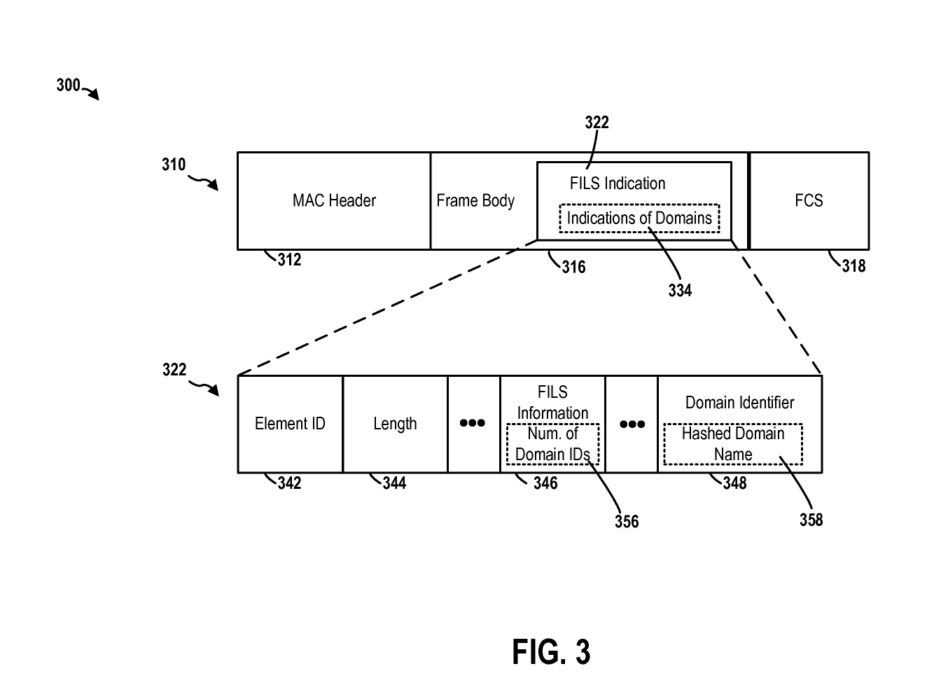

In certain configurations, the APs 242, 244 may advertise the supported domains in beacon frames. FIG. 3 is a diagram 300 illustrating a beacon frame. A beacon frame 310 includes a MAC header 312, a frame body 316, and a frame check sequence (FCS) field 318. The frame body 316 includes a fast initial link setup indication information element (FILS indication IE) 322, which includes indications 334 of a set of domains.

In certain configurations, the FILS indication IE 322 may include, among other fields, an element ID field 342, a length field 344, a FILS information field 346, and optionally one or more domain identifier fields 348. The FILS information field 346 provides information on the presence of the fields in the FILS indication IE 322. For example, the FILS information field 346 may include, among other subfields, a number-of-domain-identifiers subfield 356. The number-of-domain-identifiers subfield 356 lists the number of domain identifier fields 348 that are present in the domain identifier field 348 in the FILS indication IE 322. When the number-of-domain-identifiers subfield 356 is 0, the domain identifier field 348 is not present in the FILS indication IE 322.

The FILS indication IE 322 may include, for example, up to a preconfigured number of, i.e., M, domain identifier fields 348. In certain configurations, M may be 7. Each domain identifier field 348 may include an indication of a domain. In certain configurations, the indication may be a name, e.g., full name, of the indicated domain. In certain configurations, the indication may be a hash value of a name of the indicated domain. More specifically, each domain identifier field 348 may include a hashed-domain-name subfield 358. The value of the hashed-domain-name subfield 358 may be computed from the name of the indicated domain and that is compliant with the preferred name syntax defined in Internet Engineering Task Force (IETF) Request for Comments (RFC) 1035 “Domain Names—Implementation and Specification.” The indicated domain in the present disclosure may be a security domain or a key management domain, such as that defined in IETF RFC 6696 “EAP Extensions for the EAP Re-authentication Protocol (ERP).” In certain configurations, a key management domain is specified by the scope of a given root key. The scope is the collection of systems authorized to access key material derived from that key. Systems within a key management domain may be authorized to (1) derive key materials, (2) use key materials, or (3) distribute key materials to other systems in the same domain. A derived key's scope may be constrained to a subset of the scope of the key from which it is derived.

For each of the domain names, the hashed-domain-name subfield 358 may carry a 2-octet hash of the domain name and the Internet protocol (IP) address type of the corresponding domain. The hash operations used to generate the hash value are described in more detail infra.

Referring back to FIG. 2, in certain configurations, the 1^{st} AP 242 may use beacon frames 310 having FILS indication IEs 322 to advertise the N domains 252-1, . . . , 252-N supported by the 1^{st} AP 242. N (i.e., the number of domains supported by the 1^{st} AP 242) may be greater than M (i.e., the maximum number of domain identifier fields 348 that can be included in the FILS indication IE 322). The 1^{st} AP 242 may use more than one beacon frames 310 each containing a FILS indication IE 322 to advertise the N domains 252-1, . . . , 252-N. The 1^{st} AP 242 may use a preconfigured rule to determine the subset of domains whose indications are to be included in each beacon frame 310.

In one technique, the preconfigured rule may define that a selected subset of domains is different from each subset of one or more consecutive, previously selected subsets until each domain of the plurality of domains has been selected at least once in the one or more consecutive, previously selected subsets. For example, the ^{1st} AP 242 may store the names of the N domains 252-1, . . . , 252-N in a list and then may choose to round robin the list of domain names such that all the domain names are advertised within several beacon frames 310, each beacon frame 310 including a FILS indication IE 322 having M domain names. For example, if N=16 and M=7, the 1^{st} AP 242 may send a first beacon frame 310 indicating the domain names 1 through 7, a second beacon frame 310 indicating the domain names 8 through 14, and a third beacon frame 310 indicating the domain names 15-16 and 1-5.

In another technique, the preconfigured rule may define that the subset of domains is selected in accordance with a usage of each of the N domains 252-1, . . . , 252-N by STAs. For example, the 1^{st} AP 242 may choose to advertise only the M most popular or most utilized domain names in a beacon frame 310. The 1^{st} AP 242 may keep a record of the total times each domain is connected to by a STA. Particularly, if the 1^{st} AP 242 determines that the 1^{st}, 2^{nd}, 5^{th}, 7^{th}, 11^{th}, 12^{th}, and 15^{th} domains are the most utilized domains, the 1^{st} AP 242 may send a beacon frame 310 including a FILS indication IE 322 having the domain names 1-2, 5, 7, 11, 12, and 15. The 1^{st} AP 242 may include the remaining domain names in a probe response frame, upon receiving a probe request frame querying the 1^{st} AP 242, as described infra.

In this example, the 1^{st} STA 212 may have subscribed to the services of, and established credentials with, the 1^{st} service provider and another service provider A that is not supported by the 1^{st} AP 242. The 2^{nd} STA 222 may have subscribed to the services of, and established credentials with, the 8^{th} service provider, the 9^{th} service provider, and another service provider B that is not supported by the 1^{st} AP 242. The STAs 212, 222 each may include indications (e.g., domain names or hash of domain names) of the domains with which credentials have been established, respectively. The 1^{st} STA 212 may have credentials 216 including credentials of the 1^{st} domain 252-1 and a domain of the service provider A. The 2^{nd} STA 222 may have credentials 226 including credentials of the 8^{th} domain 252-8, the 9^{th} domain 252-9, and a domain of the service provider B.

The STAs 212, 222 may seek association with an AP. During the scanning process, the STAs 212, 222 each may receive beacon frames 310 broadcast by the 1^{st} AP 242. As described supra, the 1^{st} AP 242 may use beacon frames 310 to advise the domain names (which may be hashed) of the N domains 252-1, . . . , 252-N in a round robin manner. In this example, the 1^{st} AP 242 may broadcast a beacon frame 310 including domain names 1-7. Upon receiving this beacon frame 310, the STAs 212, 222 may match the domain names in the beacon frame 310 with the names of the domains with which they have established credentials. Accordingly, the 1^{st} STA 212 can determine that the 1^{st} AP 242 supports the 1^{st} domain 252-1, with which the 1^{st} STA 212 has established credentials. The 2^{nd} STA 222 can determine that this beacon frame 310 does not indicate a domain with which the 2^{nd} STA 222 has established credentials. The 2^{nd} STA 222 may decide to listen to additional beacon frames 310 and to match the domain names of the 2^{nd} STA 222 with the domain names indicated in the additional beacon frames 310. In this example, the 1^{st} AP 242 may include domain names 8-14 in a subsequent beacon frame 310. Upon receiving the subsequent beacon frame 310, the 2^{nd} STA 222 can determine that the 1^{st} AP 242 supports the 8^{th} domain 252-8 and the 9^{th} domain 252-9, with which the 2^{nd} STA 222 has established credentials.

Accordingly, the 2^{nd} STA 222 may select the 1^{st} AP 242 for connection. The 1^{st} STA 212 may, in accordance with the FILS procedures, construct an authentication frame including the credentials of the 1^{st} domain 252-1 and may send the authentication frame to the 1^{st} AP 242. The 1^{st} AP 242 receives the authentication frame and determines the authentication frame includes credentials directed to the 1^{st} domain 252-1. Accordingly, the 1^{st} AP 242 sends the credentials to the 1^{st} authentication server 272-1 for authentication.

The 2^{nd} STA 222 determines that the 1^{st} AP 242 supports more than one domain (i.e., the 8^{th} domain 252-8 and the 9^{th} domain 252-9) with which the 2^{nd} STA 222 has established credentials. The 2^{nd} STA 222 may select the domain that is most favored based on certain criteria such as a predetermined rule. The predetermined rule can select a domain randomly or based on a pricing agreement with the service provider, a roaming agreement with the service provider, a random logic, etc. In this example, the 2^{nd} STA 222 may decide to select the 9^{th} domain 252-9 based on the roaming agreement. As such, the 2^{nd} STA 222 may, in accordance with the FILS procedures, construct an authentication frame including the credentials of the 9^{th} domain 252-9 and may send the authentication frame to the 1^{st} AP 242. The 1^{st} AP 242 receives the authentication frame and determines the authentication frame includes credentials directed to the 9^{th} domain 252-9. Accordingly, the 1^{st} AP 242 sends the credentials to the 9^{th} authentication server 272-9 for authentication.

Alternatively, as described supra, the 1^{st} AP 242 may include the names (which may be hashed) of most popular or utilized domains in the beacon frames 310. In this example, the beacon frame 310 may include a FILS indication IE 322 having the domain names 1-2, 5, 7, 11, 12, and 15.

Upon receiving this beacon frame 310 having the names of the most popular or utilized domains, the 1^{st} STA 212 can determine that the 1^{st} AP 242 supports the 1^{st} domain 252-1, with which the 1^{st} STA 212 has established credentials. Subsequently, the 1^{st} STA 212 may initiate the authentication and association procedures with the 1^{st} AP 242 as described supra.

The 2^{nd} STA 222, which has credentials of the 8^{th} domain 252-8, the 9^{th} domain 252-9, and the domain of the service provider B, upon receiving the beacon frame 310, can determine that this beacon frame 310 does not indicate a domain with which the 2^{nd} STA 222 has established credentials. In certain configurations, the 2^{nd} STA 222 may send a probe request frame to the 1^{st} AP 242 to query the 1^{st} AP 242 regarding the domains supported by the 1^{st} AP 242. The 1^{st} AP 242 may send to the 2^{nd} STA 222 a probe response frame including indications of the domains supported by the 1^{st} AP 242 in response.

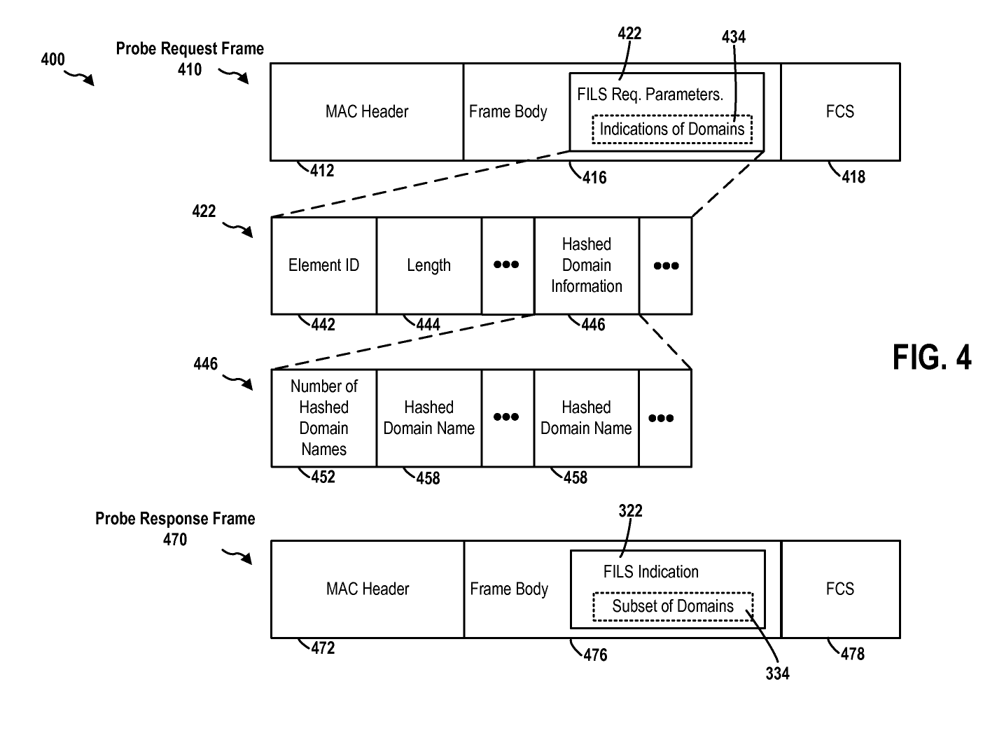

FIG. 4 is a diagram 400 illustrating a probe request frame. A probe request frame 410 includes a MAC header 412, a frame body 416, and an FCS field 418. The frame body 416 includes a FILS request parameters element 422, which may include indications 434 of one or more domains. In certain configurations, the FILS request parameters element 422 may include, among other fields, an element ID field 442, a length field 444, a hashed domain information field 446.

The hashed domain information field 446 may include, among other subfields, a number-of-hashed-domain-names subfield 452 and one or more hashed-domain-name subfields 458. The number-of-hashed-domain-names subfield 452 indicates a positive unsigned number of hashed-domain-name subfields 458 in the hashed domain information field 446. The value of the hashed-domain-name subfield 458 may be the hash value of a domain name to be included. The hash value is obtained by using hash operations that are similar to the hash operations described supra with respect to the hashed-domain-name subfield 358 and that will be described in more detail infra.

Referring back to FIG. 2, in certain configurations, the 2^{nd} STA 222 may construct a probe request frame 410 and includes, in the FILS request parameters element 422, the names of the domains of which the 2^{nd} STA 222 has established credentials. In this example, the 2^{nd} STA 222 includes the names (which may be hashed) of the 8th domain 252-8, the 9^{th} domain 252-9, and the domain B in the FILS request parameters element 422. The probe request frame 410 may further include a hash of each service set identifier (SSID) of a set of service set identifiers (SSIDs). The SSID may be associated with an establishment within which the 1^{st} AP 242 resides.

The 1^{st} AP 242, upon receiving the probe request frame 410, matches the domain names contained in the probe request frame 410 with the names of the N domains 252-1, . . . , 252-N. The 1^{st} AP 242 can determine the matched domains within the N domains 252-1, . . . , 252-N with which the 2^{nd} STA 222 has established credentials.

The 1^{st} AP 242 then may include the names of the matched domains in a probe response frame and may send the probe response frame to the 2^{nd} STA 222. In this example, the 1^{st} AP 242 determines that the matched domains include the 8^{th} domain 252-8 and the 9^{th} domain 252-9. Accordingly, the 1^{st} AP 242 includes domain names 8-9 in the probe response frame.

If no match is found, the 1^{st} AP 242 may include the names of all the N domains 252-1, . . . , 252-N in the probe response frame and send the probe response frame to the 2^{nd} STA 222. Alternatively, the 1^{st} AP 242 may not send a probe response frame at all and may ignore the probe request frame 410, when no match is found.

FIG. 4 further shows an exemplary probe response frame 470. The probe response frame 470 includes a MAC header 472, a frame body 476, and an FCS field 478. The frame body 476 includes the FILS indication IE 322 described supra referring to FIG. 3. The 1^{st} AP 242 may include in the FILS indication IE 322 indications 334 of all or the matched domains of the N domains 252-1, . . . , 252-N, as described supra. Particularly, the FILS indication IE 322 of the probe response frame 470 may be configured to include, for example, N domain identifier fields 348 in order to include indications for all the N domains 252-1, . . . , 252-N.

Referring back to FIG. 2, the 2^{nd} STA 222, upon receiving a probe response frame 470 containing indications of matching domains, may proceed with authentication/association with the 1^{st} AP 242 by selecting one of the matching domain names. As described supra, in case of a multiple match, the 2^{nd} STA 222 may select the domain that is most favored based on certain criteria such as a predetermined rule. The predetermined rule can select a domain based on a pricing agreement with the service provider, a roaming agreement with the service provider, a random logic, etc. In some implementations, the 2^{nd} STA 222 may choose based on the number of messages involved in the authentication/association process. In this example, the 2^{nd} STA 222 may determine that the 8^{th} domain 252-8 and 9th domain 252-9 are the matching domains. The 2^{nd} STA 222 may decide to select the 9^{th} domain 252-9 based on pricing. Subsequently, the 2^{nd} STA 222 may, in accordance with the FILS procedures, construct an authentication frame including the credentials of the 9^{th} domain 252-9 and may send the authentication frame to the 1^{st} AP 242. The 1^{st} AP 242 receives the authentication frame and determines the authentication frame includes credentials directed to the 9^{th} domain 252-9.

Accordingly, the 1^{st} AP 242 sends the credentials to the 9^{th} authentication server 272-9 for authentication.

In certain configurations, if the 1^{st} STA 212 or the 2^{nd} STA 222 does not receive a response from the 1^{st} AP 242 or the 2^{nd} AP 244 within a reasonable or predetermined time or receives in a probe response frame a list of domain names that do not match with any of the domain names with which the STA has established credentials, the STA may not seek authentication/association with the AP.

As described supra, in this example, the 2^{nd} AP 244 supports the 7^{th} domain 252-7, the 8^{th} domain 252-8, and the 9^{th} domain 252-9. The STAs 212, 222 receive indications of the domains supported by the 2^{nd} AP 244 through the FILS indication IEs 322 included in beacon frames 310 or probe response frames 470, as described supra, transmitted by the 2^{nd} AP 244. Based on that information, the 1^{st} STA 212 can determine that the 2^{nd} AP 244 does not support any domain with which the 1st STA 212 has established credentials. As such, the 1^{st} AP 242 may decide to only seek association with the 1^{st} AP 242, but not with the 2^{nd} AP 244, as the 1^{st} STA 212 has determined that the 1^{st} AP 242 supports a domain (i.e., the 1^{st} domain 252-1) with which the 1^{st} STA 212 has established credentials, as described supra.

In certain configurations, the STAs 212, 222 and the APs 242, 244 may use the operations described herein to generate a hash value of a domain name. Initially, internationalized domain names are converted to an IETF RFC 1035 compliant ASCII form using the operations defined in IETF RFC 3490 “Internationalizing Domain Names in Applications (IDNA).” Then the hash of the domain name (IETF RFC 1035 compliant) may be computed as follows:

H=L(CRC32(x), 0, 16), 0, 15)

where:
H is the hashed domain name.
CRC32(x) may be calculated by using G(x) function, which is a standard generator polynomial of degree 32:

G(x)=x³²+x²⁶+x²³+x²²+x¹⁶+x¹²+x¹¹+x¹⁰+x⁸+x⁷+x⁵+x⁴+x²+x+1; and
x is ToLowerCase(D), and ToLowerCase () is the function that converts upper case characters to lower case.
L(Str, F, L) is defined as an operation that, starting from the left of Str (i.e., a string), extracts bits F to F+L1. All bits within Str are numbered consecutively starting from 0 to k, where the length of the Str is k+1 bits and k is a positive integer.
D for an AP may be a network access identifier (NAI) realm corresponding to the service provider providing the domain. NAI Realm may be a string formatted in accordance with IETF RFC 4282 “The Network Access Identifier” or a UTF-8 formatted character string that is not formatted in accordance with IETF RFC 4282. Alternatively, D for an AP may a home network realm such as in the form of an Internet domain name, e.g., operator.com, as specified in IETF RFC 1035.
D for a non-AP STA may be a NAI Realm used in the EAP-Response/Identity of the initial full EAP authentication.

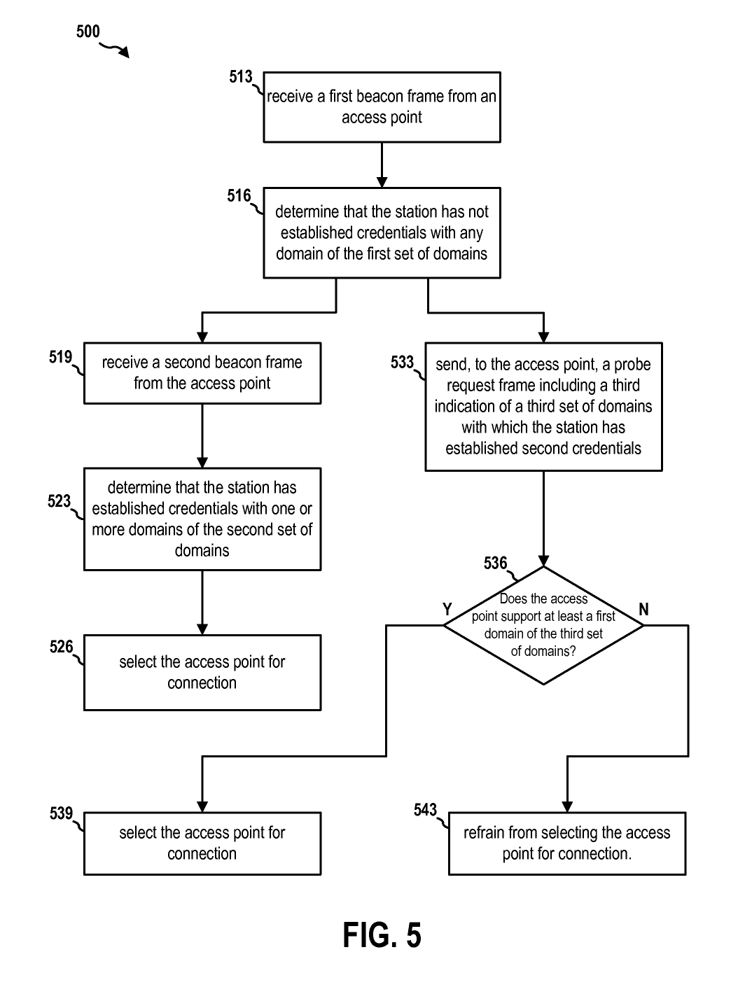

FIG. 5 is a flow chart 500 of a method (process) for selecting an access point for connection. The method may be performed by a station (e.g., the STA 114, the STAs 212, 222, the wireless device 1100/1202).

At operation 513, the station receives a first beacon frame from an access point. The first beacon frame includes a first indication of a first set of domains that are supported by the access point. For example, referring to FIG. 2, the 2^{nd} STA 222 receives a beacon frame 310 including domain names 1-7 from the 1^{st} AP 242. At operation 516, the station determines that the station has not established credentials with any one domain of the first set of domains. For example, referring to FIG. 2, upon receiving the initial beacon frame 310, the 2^{nd} STA 222 may match the domain names in the beacon frame 310 with the names of the domains with which the 2^{nd} STA 222 has established credentials. The 2^{nd} STA 222 can determine that this beacon frame 310 does not indicate a domain with which the 2^{nd} STA 222 has established credentials.

In certain configurations, subsequent to operation 516, the station receives, at operation 519, a second beacon frame from the access point. The second beacon frame includes a second indication of a second set of domains that are supported by the access point. The first set of domains is different from the second set of domains. For example, referring to FIG. 2, the 2^{nd} STA 222 may decide to listen to additional beacon frames 310 and to match the domain names of the 2^{nd} STA 222 with the domain names indicated in the additional beacon frames 310. In this example, the 1^{st} AP 242 may include domain names 8-14 in a subsequent beacon frame 310.

At operation 523, the station determines that the station has established third credentials with one or more domains of the second set of domains. For example, referring to FIG. 2, the 2^{nd} STA 222 can determine that the 1^{st} AP 242 supports the 8^{th} domain 252-8 and the 9^{th} domain 252-9, with which the 2^{nd} STA 222 has established credentials. At operation 526, the station selects the access point for connection. For example, referring to FIG. 2, the 2^{nd} STA 222 may select the 1^{st} AP 242 for connection. The 1^{st} STA 212 may, in accordance with the FILS procedures, construct an authentication frame including the credentials of the 1^{st} domain 252-1 and may send the authentication frame to the 1^{st} AP 242.

In certain configurations, subsequent to operation 516, the station sends, at operation 533, to the access point a probe request frame including a third indication of a third set of domains with which the station has established second credentials. For example, referring to FIG. 2, the 2^{nd} STA 222 may construct a probe request frame 410 and includes, in the FILS request parameters element 422, the names of the domains of which the 2^{nd} STA 222 has established credentials.

At operation 536, the station determines whether the access point supports at least a first domain of the third set of domains based on a behavior of the access point. When the access point is determined to support the first domain of the third set of domains, at operation 539, the station selects the access point for connection. When the access point is determined to not support any domain of the third set of domains, at operation 543, the station refrains from selecting the access point connection. In certain configurations, an indication of each given domain of the first set of domains, the second set of domains, and the third set of domains is a hash of a name of the given domain or a full name of the given domain.

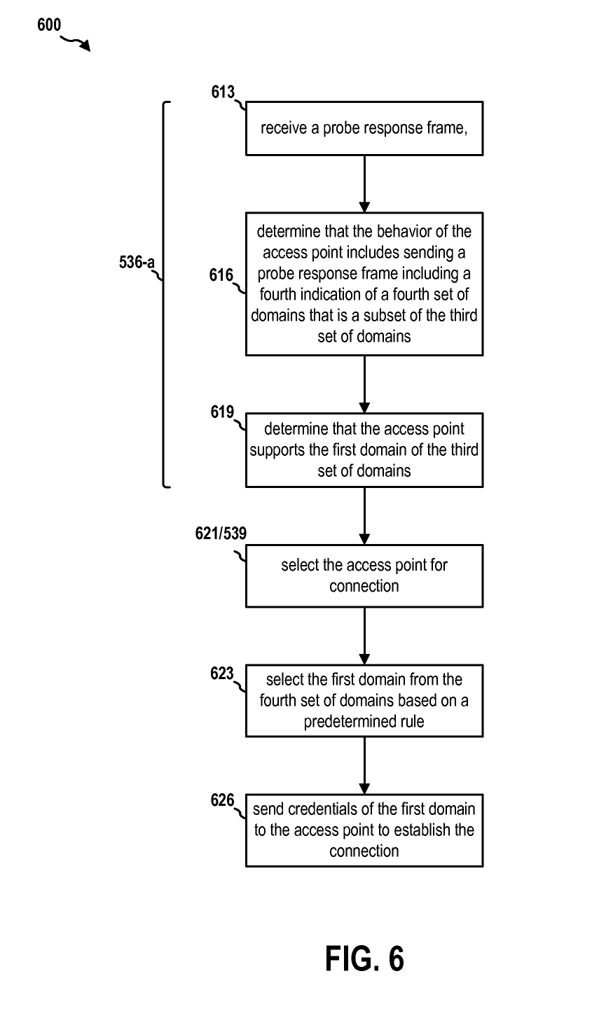

FIG. 6 is a flow chart 600 of a method (process) for selecting an access point for connection based on a probe response frame. The method may be performed by a station (e.g., the STA 114, the STAs 212, 222, the wireless device 1100/1202). In certain configurations, within operation 536, the station may perform a set of operations 536-a that includes operations 613, 616, and 619.

More specifically, at operation 613, the station receives a probe response frame. At operation 616, the station determines that the behavior of the access point includes sending the probe response frame to the station. The probe response frame includes a fourth indication of a fourth set of domains. The fourth set of domains is a subset of the third set of domains. At operation 619, the station determines that the access point supports the first domain of the third set of domains. Subsequent to operation 619, the station, at operation 621, selects the access point for connection. Operation 621 is the same as operation 539 illustrated in FIG. 5. In certain configurations, the fourth set of domains includes at least two domains. At operation 623, the station selects the first domain from the fourth set of domains based on a predetermined rule. In certain configurations, the predetermined rule selects a domain from a plurality of domains randomly or based on a roaming agreement, a pricing agreement. At operation 626, the station sends credentials of the first domain to the access point to establish the connection. The first domain is in the fourth set of domains.

For example, referring to FIG. 2, the 1^{st} AP 242 then may include the names of the matched domains in a probe response frame and may send the probe response frame to the 2^{nd} STA 222. The 2^{nd} STA 222, upon receiving a probe response frame 470 containing indications of matching domains, may proceed with authentication/association with the 1^{st} AP 242 by selecting one of the matching domain names.

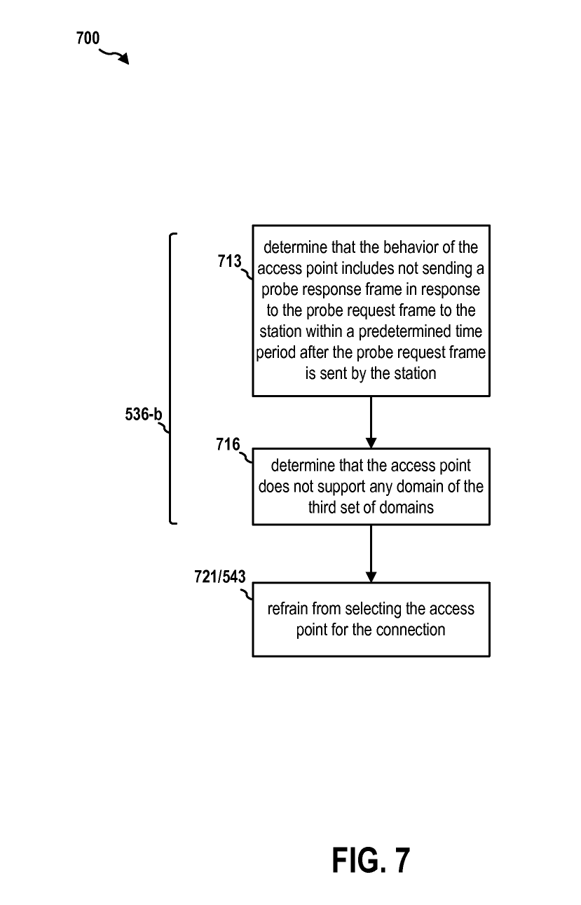

FIG. 7 is a flow chart 700 of a method (process) for not selecting an access point for connection based on lack of a response from the access point. The method may be performed by a station (e.g., the STA 114, the STAs 212, 222, the wireless device 1100/1202). In certain configurations, within operation 536, the station may perform a set of operations 536-b that includes operations 713 and 716. More specifically, at operation 713, the station determines that the behavior of the access point includes not sending a probe response frame in response to the probe request frame to the station within a predetermined time period after the probe request frame is sent by the station. At operation 716, the station determines that the access point does not support any domain of the third set of domains. Subsequent to operation 716, the station, at operation 721, refrains from selecting the access point for the connection. Operation 721 is the same as operation 543 illustrated in FIG. 5.

For example, referring to FIG. 2, if the 1^{st} STA 212 or the 2^{nd} STA 222 does not receive a response from the 1^{st} AP 242 or the 2^{nd} AP 244 within a reasonable or predetermined time, the STA may not seek authentication/association with the AP.

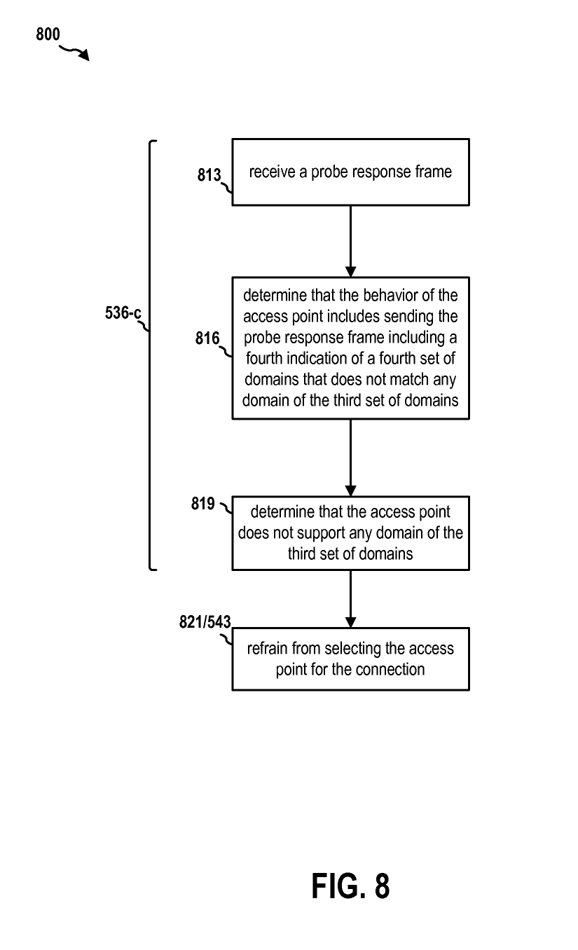

FIG. 8 is a flow chart 800 of a method (process) for not selecting an access point for connection based on a probe response frame. The method may be performed by a station (e.g., the STA 114, the STAs 212, 222, the wireless device 1100/1202). In certain configurations, within operation 536, the station may perform a set of operations 536c that includes operations 813, 816, and 819. More specifically, at operation 813, the station receives a probe response frame. At operation 816, the station determines that the behavior of the access point includes sending the probe response frame to the station. The probe response frame includes a fourth indication of a fourth set of domains. The fourth set of domains does not match any domain of the third set of domains. At operation 819, the station determines that the access point does not support any domain of the third set of domains. Subsequent to operation 819, the station, at operation 821, refrains from selecting the access point for the connection. Operation 821 is the same as operation 543 illustrated in FIG. 5.

For example, referring to FIG. 2, if the 1^{st} STA 212 or the 2^{nd} STA 222 receives in a probe response frame a list of domain names that do not match with any of the domain names with which the STA has established credentials, the STA may not seek authentication/association with the AP.

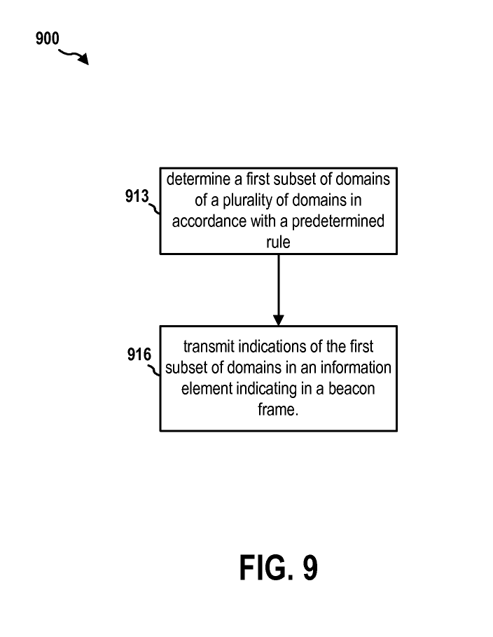

FIG. 9 is a flow chart 900 of a method (process) for advertising supported domains via a beacon frame. The method may be performed by an access point (e.g., the AP 104, the APs 242, 244, the wireless device 1100/1202).

At operation 913, the access point determines a first subset of domains of a plurality of domains in accordance with a predetermined rule. Each of the plurality of domains is associated with a service provider. The predetermined rule may define that the first subset of domains is selected in accordance with a usage of each of the plurality of domains by stations. Alternatively, the predetermined rule may define that a selected subset of domains is different from each subset in one or more consecutive, previously selected subsets until each of the plurality of domains has been included at least once in the one or more consecutive, previously selected subsets. At operation 916, the access point transmits a first indication of the first subset of domains in an information element in a beacon frame.

In certain configurations, the information element is an FILS indication IE. In certain configurations, the predetermined rule further defines that the selected subset of domains that is different from each subset of one or more consecutive, previously selected subsets is selected from the plurality of domains in a round robin manner. In certain configurations, the information element carries indications of a maximum number of M domains, M being a positive integer. The plurality of domains includes more than M domains. In certain configurations, the predetermined rule further defines that the first subset of domains that is selected in accordance with the usage of each of the first subset of domains includes M most used domains. In certain configurations, an indication of each given domain of the plurality of domains is a hash of a name of the given domain or a full name of the given domain.

For example, referring to FIG. 2, the 1^{st} AP 242 may store the names of the N domains 252-1, . . . , 252-N in a list and then may choose to round robin the list of domain names such that all the domain names are advertised within several beacon frames 310, each beacon frame 310 including a FILS indication IE 322 having M domain names. Alternatively, the 1^{st} AP 242 may choose to advertise only the M most popular or most utilized domain names in a beacon frame 310.

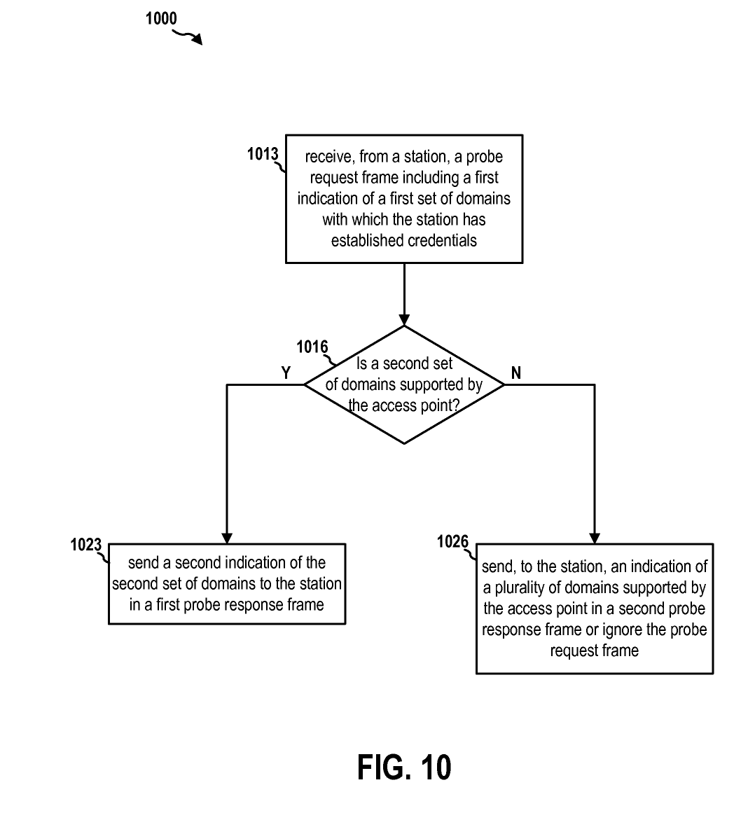

FIG. 10 is a flow chart 1000 of a method (process) for advertising supported domains via a probe response frame. The method may be performed by an access point (e.g., the AP 104, the APs 242, 244, the wireless device 1100/1202). At operation 1013, the access point receives, from a station, a probe request frame including a first indication of a first set of domains with which the station has established credentials. At operation 1016, the access point determines whether a second set of domains is supported by the access point. The second set of domains is a subset of the first set of domains. When the second set of domains is determined to be supported by the access point, the access point, at operation 1023, sends a second indication of the second set of domains to the station in a first probe response frame. When none of the first set of domains is determined to be supported by the access point, the access point, at operation 1026, sends to the station an indication of a plurality of domains supported by the access point in a second probe response frame or ignoring the probe request frame. In certain configurations, the indication of each given domain of the plurality of domains, the first set of domains, and the second set of domains is a hash of a name of the given domain or a full name of the given domain.

For example, referring to FIG. 2, the 1^{st} AP 242, upon receiving the probe request frame 410, matches the domain names contained in the probe request frame 410 with the names of the N domains 252-1, . . . , 252-N. The 1^{st} AP 242 can determine the matched domains within the N domains 252-1, . . . , 252-N with which the 2^{nd} STA 222 has established credentials. The 1^{st} AP 242 then may include the names of the matched domains in a probe response frame and may send the probe response frame to the 2^{nd} STA 222. In this example, the 1^{st} AP 242 determines that the matched domains include the 8^{th} domain 252-8 and the 9^{th} domain 252-9. Accordingly, the 1^{st} AP 242 includes domain names 8-9 in the probe response frame. If no match is found, the 1^{st} AP 242 may include the names of all the N domains 252-1, . . . , 252-N in the probe response frame and send the probe response frame to the 2^{nd} STA 222. Alternatively, the 1^{st} AP 242 may not send a probe response frame at all and may ignore the probe request frame 410, when no match is found.

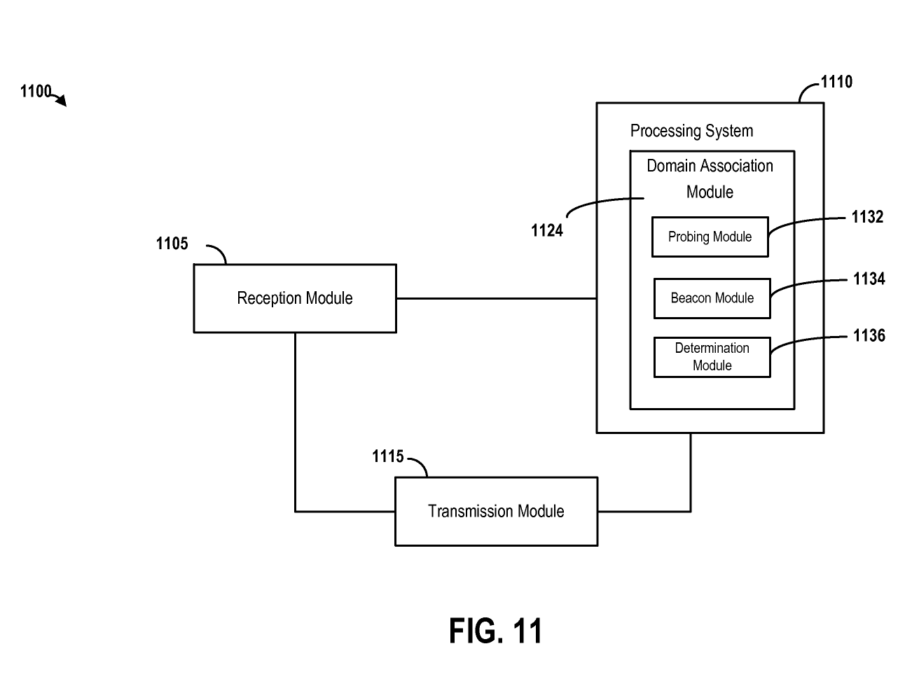

FIG. 11 is a functional block diagram of an example wireless communication device 1100. The wireless communication device 1100 may include a reception module/circuitry 1105, a transmission module/circuitry 1115, and a processing system 1110. The processing system 1110 may include a domain association module/circuitry 1124. The domain association module/circuitry 1124 may be configured to perform the various functions recited herein. More specifically, the domain association module/circuitry 1124 may include a probing module/circuitry 1132, a beacon module/circuitry 1134, and a determination module/circuitry 1136.

In one aspect, the wireless communication device 1100 may be a station. The beacon module/circuitry 1134 and/or the reception module/circuitry 1105 may be configured to receive a first beacon frame from an access point. The first beacon frame includes a first indication of a first set of domains that are supported by the access point. The determination module/circuitry 1136 may be configured to determine that the station has not established credentials with any one domain of the first set of domains. In certain configurations, the beacon module/circuitry 1134 and/or the reception module/circuitry 1105 may be configured to receive a second beacon frame from the access point. The second beacon frame includes a second indication of a second set of domains that are supported by the access point. The first set of domains is different from the second set of domains. In certain configurations, the probing module/circuitry 1132 and/or the transmission module/circuitry 1115 may be configured to send, to the access point, a probe request frame including a third indication of a third set of domains with which the station has established second credentials.

In certain configurations, the second beacon frame is received from the access point.

The determination module/circuitry 1136 may be configured to determine that the station has established third credentials with one or more domains of the second set of domains. The determination module/circuitry 1136 may be configured to select the access point for connection.

In certain configurations, the probe request frame is sent to the access point. The determination module/circuitry 1136 may be configured to determine whether the access point supports at least a first domain of the third set of domains based on a behavior of the access point. The determination module/circuitry 1136 may be configured to select the access point for connection when the access point is determined to support the first domain of the third set of domains.

In certain configurations, the probing module/circuitry 1132 and/or the reception module/circuitry 1105 may be configured to receive a probe response frame. The determination module/circuitry 1136 may be configured to determine that the behavior of the access point includes sending the probe response frame to the station. The probe response frame includes a fourth indication of a fourth set of domains. The fourth set of domains is a subset of the third set of domains. The access point is determined to support the first domain of the third set of domains.

The transmission module/circuitry 1115 may be configured to sending credentials of the first domain to the access point to establish the connection. The first domain is in the fourth set of domains. In certain configurations, the fourth set of domains includes at least two domains. The determination module/circuitry 1136 may be configured to select the first domain from the fourth set of domains based on a predetermined rule. In certain configurations, the predetermined rule selects a domain from a plurality of domains randomly or based on a roaming agreement or a pricing agreement.

In certain configurations, the determination module/circuitry 1136 may be configured to determine that the behavior of the access point includes not sending a probe response frame in response to the probe request frame to the station within a predetermined time period after the probe request frame is sent by the station. The access point is determined to not support any domain of the third set of domains. The determination module/circuitry 1136 may be configured to refrain from selecting the access point for the connection.

In certain configurations, the probing module/circuitry 1132 and/or the reception module/circuitry 1105 may be configured to receive a probe response frame. The determination module/circuitry 1136 may be configured to determine that the behavior of the access point includes sending the probe response frame to the station. The probe response frame includes a fourth indication of a fourth set of domains. The fourth set of domains does not match any domain of the third set of domains. The access point is determined to not support the first domain of the third set of domains. The determination module/circuitry 1136 may be configured to refrain from selecting the access point for the connection. In certain configurations, an indication of each given domain of the first set of domains, the second set of domains, and the third set of domains is a hash of a name of the given domain or a full name of the given domain.

In another aspect, the wireless communication device 1100 may be an access point. In certain configurations, the determination module/circuitry 1136 may be configured to determining a first subset of domains of a plurality of domains in accordance with a predetermined rule. Each of the plurality of domains is associated with a service provider. The predetermined rule defines that the first subset of domains is selected in accordance with a usage of each of the plurality of domains by stations. Alternatively, the predetermined rule defines that a selected subset of domains is different from each subset in one or more consecutive, previously selected subsets until each of the plurality of domains has been included at least once in the one or more consecutive, previously selected subsets. The beacon module/circuitry 1134 and/or the transmission module/circuitry 1115 may be configured to transmit a first indication of the first subset of domains in an information element in a beacon frame. In certain configurations, the information element is a FILS indication IE.

In certain configurations, the predetermined rule further defines that the selected subset of domains that is different from each subset of one or more consecutive, previously selected subsets is selected from the plurality of domains in a round robin manner. In certain configurations, the information element carries indications of a maximum number of M domains, M being a positive integer. The plurality of domains includes more than M domains. In certain configurations, the predetermined rule further defines that the first subset of domains that is selected in accordance with the usage of each of the first subset of domains includes M most used domains. In certain configurations, an indication of each given domain of the plurality of domains is a hash of a name of the given domain or a full name of the given domain.

In certain configurations, the probing module/circuitry 1132 and/or the reception module/circuitry 1105 may be configured to receive, from a station, a probe request frame including a first indication of a first set of domains with which the station has established credentials. The determination module/circuitry 1136 may be configured to determine whether a second set of domains is supported by the access point. The second set of domains is a subset of the first set of domains. The probing module/circuitry 1132 and/or the transmission module/circuitry 1115 may be configured to send a second indication of the second set of domains to the station in a first probe response frame when the second set of domains is determined to be supported by the access point.

In certain configurations, the probing module/circuitry 1132 and/or the transmission module/circuitry 1115 may be configured to send, to the station, an indication of a plurality of domains supported by the access point in a second probe response frame or ignoring the probe request frame, when none of the first set of domains is determined to be supported by the access point. In certain configurations, the indication of each given domain of the plurality of domains, the first set of domains, and the second set of domains is a hash of a name of the given domain or a full name of the given domain.

The apparatus may include additional modules that perform each of the blocks of the algorithm in the aforementioned flowcharts of FIGS. 5-10. As such, each block in the aforementioned flowcharts of FIGS. 5-10 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

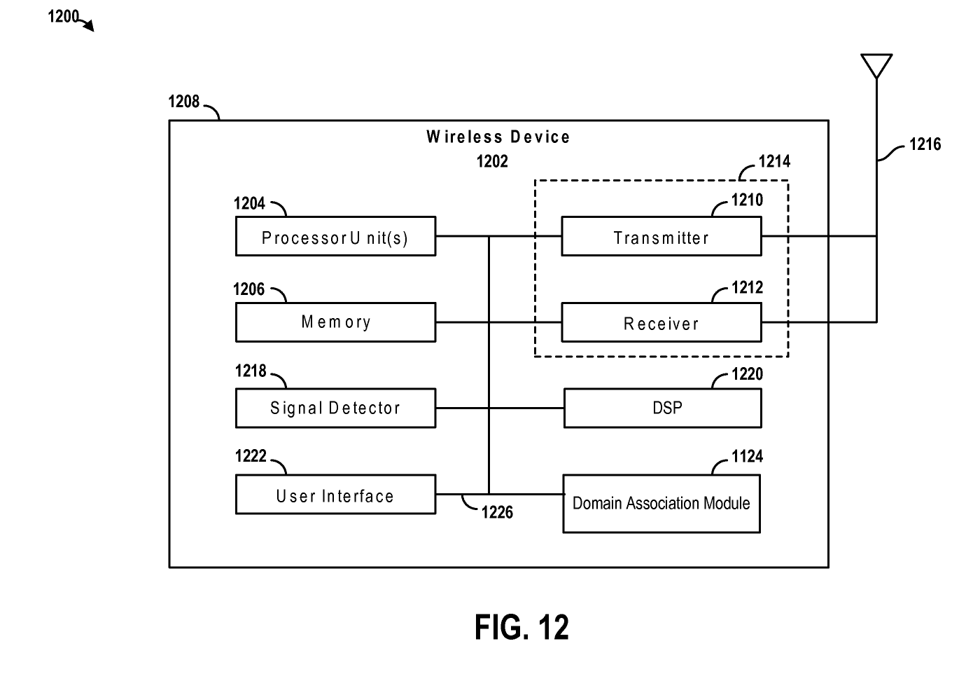

FIG. 12 is a diagram 1200 illustrating an example of a hardware implementation of a wireless device 1202 that may be employed within the wireless communication system 100 of FIG. 1 or the wireless network of FIG. 2. The wireless device 1202 is an example of a device that may be configured to implement the various methods described herein. For example, the wireless device 1202 may include one of the STA 114 and the STAs 212, 222 or one of the AP 104 and the APs 242, 244.

The wireless device 1202 may include a processor 1204 which controls operation of the wireless device 1202. The processor 1204 may also be referred to as a central processing unit (CPU). Memory 1206, which may include both read-only memory (ROM) and random access memory (RAM), may provide instructions and data to the processor 1204. A portion of the memory 1206 may also include non-volatile random access memory (NVRAM). The processor 1204 typically performs logical and arithmetic operations based on program instructions stored within the memory 1206. The instructions in the memory 1206 may be executable (by the processor 1204, for example) to implement the methods described herein.

The processor 1204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 1202 may also include a housing 1208 that may include a transmitter 1210 and/or a receiver 1212 to allow transmission and reception of data between the wireless device 1202 and a remote device. The transmitter 1210 and the receiver 1212 may be combined into a transceiver 1214. An antenna 1216 may be attached to the housing 1208 and electrically coupled to the transceiver 1214. The wireless device 1202 may also include (not shown) multiple transmitters, multiple receivers, multiple transceivers, and/or multiple antennas.

The wireless device 1202 may also include a signal detector 1218 that may be used to detect and quantify the level of signals received by the transceiver 1214 or the receiver 1212. The signal detector 1218 may detect such signals as total energy, energy per subcarrier per symbol, power spectral density, and other signals. The wireless device 1202 may also include a digital signal processor (DSP) 1220 for use in processing signals. The DSP 1220 may be configured to generate a packet for transmission. In some aspects, the packet may comprise a physical layer data unit (PPDU).

The wireless device 1202 may further comprise a user interface 1222 in some aspects. The user interface 1222 may comprise a keypad, a microphone, a speaker, and/or a display. The user interface 1222 may include any element or component that conveys information to a user of the wireless device 1202 and/or receives input from the user.

The wireless device 1202 also includes the domain association module/circuitry 1124. The processor 1204, the memory 1206, the signal detector 1218, the DSP 1220, the user interface 1222, and the domain association module/circuitry 1124 may constitute the processing system 1110. The processor 1204, the memory 1206, and the transceiver 1214 may constitute the transmission module/circuitry 1115 and the reception module/circuitry 1105. As described supra, the domain association module/circuitry 1124 includes the probing module/circuitry 1132, the beacon module/circuitry 1134, and the determination module/circuitry 1136. Each of the probing module/circuitry 1132, the beacon module/circuitry 1134, and the determination module/circuitry 1136 may employ, among other components, the processor 1204 and the memory 1206.

The various components of the wireless device 1202 may be coupled together by a bus system 1226. The bus system 1226 may include a data bus, for example, as well as a power bus, a control signal bus, and a status signal bus in addition to the data bus. Components of the wireless device 1202 may be coupled together or accept or provide inputs to each other using some other mechanism.

Although a number of separate components are illustrated in FIG. 12, one or more of the components may be combined or commonly implemented. For example, the processor 1204 may be used to implement not only the functionality described above with respect to the processor 1204, but also to implement the functionality described above with respect to the signal detector 1218, the DSP 1220, the user interface 1222, and/or the domain association module/circuitry 1124. Further, each of the components illustrated in FIG. 12 may be implemented using a plurality of separate elements.

In one aspect, the wireless device 1100/1202 may be a station. The wireless device 1100/1202 may include means for receiving a first beacon frame from an access point. The first beacon frame includes a first indication of a first set of domains that are supported by the access point.

The wireless device 1100/1202 may include means for determining that the station has not established credentials with any one domain of the first set of domains. The wireless device 1100/1202 may include means for receiving a second beacon frame from the access point. The second beacon frame includes a second indication of a second set of domains that are supported by the access point. The first set of domains is different from the second set of domains. The wireless device 1100/1202 may include means for sending, to the access point, a probe request frame including a third indication of a third set of domains with which the station has established second credentials.

In certain configurations, the wireless device 1100/1202 may include means for determining that the station has established third credentials with one or more domains of the second set of domains. The wireless device 1100/1202 may include means for selecting the access point for connection.

In certain configurations, the wireless device 1100/1202 may include means for determining whether the access point supports at least a first domain of the third set of domains based on a behavior of the access point. The wireless device 1100/1202 may include means for selecting the access point for connection when the access point is determined to support the first domain of the third set of domains.

In certain configurations, the wireless device 1100/1202 may include means for receiving a probe response frame. The wireless device 1100/1202 may include means for determining that the behavior of the access point includes sending the probe response frame to the station. The probe response frame includes a fourth indication of a fourth set of domains. The fourth set of domains is a subset of the third set of domains. The access point is determined to support the first domain of the third set of domains. The wireless device 1100/1202 may include means for sending credentials of the first domain to the access point to establish the connection. The first domain is in the fourth set of domains.

In certain configurations, the fourth set of domains includes at least two domains. The wireless device 1100/1202 may include means for selecting the first domain from the fourth set of domains based on a predetermined rule. In certain configurations, the predetermined rule selects a domain from a plurality of domains randomly or based on a roaming agreement or a pricing agreement.

In certain configurations, the wireless device 1100/1202 may include means for determining that the behavior of the access point includes not sending a probe response frame in response to the probe request frame to the station within a predetermined time period after the probe request frame is sent by the station. The access point is determined to not support any domain of the third set of domains. The wireless device 1100/1202 may include means for refraining from selecting the access point for the connection.

In certain configurations, the wireless device 1100/1202 may include means for receiving a probe response frame. The wireless device 1100/1202 may include means for determining that the behavior of the access point includes sending the probe response frame to the station. The probe response frame includes a fourth indication of a fourth set of domains. The fourth set of domains does not match any domain of the third set of domains. The access point is determined to not support any domain of the third set of domains. The wireless device 1100/1202 may include means for refraining from selecting the access point for the connection. In certain configurations, an indication of each given domain of the first set of domains, the second set of domains, and the third set of domains is a hash of a name of the given domain or a full name of the given domain.

In another aspect, the wireless device 1100/1202 may be an access point. The wireless device 1100/1202 may include means for determining a first subset of domains of a plurality of domains in accordance with a predetermined rule. Each of the plurality of domains is associated with a service provider. The predetermined rule may define that the first subset of domains is selected in accordance with a usage of each of the plurality of domains by stations. Alternatively, the predetermined rule may define that a selected subset of domains is different from each subset in one or more consecutive, previously selected subsets until each of the plurality of domains has been included at least once in the one or more consecutive, previously selected subsets. The wireless device 1100/1202 may include means for transmitting a first indication of the first subset of domains in an information element in a beacon frame. In certain configurations, the information element is a FILS indication IE.

In certain configurations, the predetermined rule further defines that the selected subset of domains that is different from each subset of one or more consecutive, previously selected subsets is selected from the plurality of domains in a round robin manner. In certain configurations, the information element carries indications of a maximum number of M domains. M is a positive integer. The plurality of domains includes more than M domains. In certain configurations, the predetermined rule further defines that the first subset of domains that is selected in accordance with the usage of each of the first subset of domains includes M most used domains. In certain configurations, an indication of each given domain of the plurality of domains is a hash of a name of the given domain or a full name of the given domain.

In yet another aspect, the wireless device 1100/1202 may be an access point. The wireless device 1100/1202 may include means for receiving, from a station, a probe request frame including a first indication of a first set of domains with which the station has established credentials. The wireless device 1100/1202 may include means for determining whether a second set of domains is supported by the access point, the second set of domains being a subset of the first set of domains. The wireless device 1100/1202 may include means for sending a second indication of the second set of domains to the station in a first probe response frame when the second set of domains is determined to be supported by the access point. In certain configurations, the wireless device 1100/1202 may include means for sending, to the station, an indication of a plurality of domains supported by the access point in a second probe response frame or ignoring the probe request frame, when none of the first set of domains is determined to be supported by the access point. In certain configurations, the indication of each given domain of the plurality of domains, the first set of domains, and the second set of domains is a hash of a name of the given domain or a full name of the given domain.

The aforementioned means may be one or more of the aforementioned modules of the wireless device 1100/1202 configured to perform the functions recited by the aforementioned means. The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of wireless communication of a station, comprising:
receiving a first beacon frame from an access point, wherein the first beacon frame includes a first indication of a first set of domains that are supported by the access point;
determining that the station has not established credentials with any one domain of the first set of domains; and
performing at least one of
(a) receiving a second beacon frame from the access point, wherein the second beacon frame includes a second indication of a second set of domains that are supported by the access point, wherein the first set of domains is different from the second set of domains; or
(b) sending, to the access point, a probe request frame including a third indication of a third set of domains with which the station has established second credentials.

2. The method of claim 1, wherein the first indication is included in a first fast initial link setup indication information element (FILS indication IE) of the first beacon frame, wherein the second indication is in included in a second FILS indication IE of the second beacon frame, and wherein the third indication is included in a FILS request parameters element of the probe request frame.

3. The method of claim 1, wherein the second beacon frame is received from the access point, the method further comprising:
determining that the station has established third credentials with one or more domains of the second set of domains; and
selecting the access point for connection.

4. The method of claim 1, wherein the probe request frame is sent to the access point, the method further comprising:
determining whether the access point supports at least a first domain of the third set of domains based on a behavior of the access point; and
selecting the access point for connection when the access point is determined to support the first domain of the third set of domains.

5. The method of claim 4, further comprising:
receiving a probe response frame;
determining that the behavior of the access point includes sending the probe response frame to the station, wherein the probe response frame includes a fourth indication of a fourth set of domains, wherein the fourth set of domains is a subset of the third set of domains, and wherein the access point is determined to support the first domain of the third set of domains; and
sending credentials of the first domain to the access point to establish the connection, wherein the first domain is in the fourth set of domains.

6. The method of claim 5, wherein the fourth set of domains includes at least two domains, the method further comprising:
selecting the first domain from the fourth set of domains based on a predetermined rule.

7. The method of claim 6, wherein the predetermined rule selects a domain from a plurality of domains randomly or based on a roaming agreement or a pricing agreement.

8. The method of claim 4, further comprising:
determining that the behavior of the access point includes not sending a probe response frame in response to the probe request frame to the station within a predetermined time period after the probe request frame is sent by the station, wherein the access point is determined to not support any domain of the third set of domains; and
refraining from selecting the access point for the connection.

9. The method of claim 4, further comprising:
receiving a probe response frame;
determining that the behavior of the access point includes sending the probe response frame to the station, wherein the probe response frame includes a fourth indication of a fourth set of domains, wherein the fourth set of domains does not match any domain of the third set of domains, wherein the access point is determined to not support any domain of the third set of domains; and
refraining from selecting the access point for the connection.

10. The method of claim 4, wherein an indication of each given domain of the first set of domains, the second set of domains, and the third set of domains is a hash of a name of the given domain or a full name of the given domain.

11. A method of wireless communication of an access point, comprising:
determining a first subset of domains of a plurality of domains in accordance with a predetermined rule, wherein each of the plurality of domains is associated with a service provider, and wherein the predetermined rule defines:
that the first subset of domains is selected in accordance with a usage of each of the plurality of domains by stations, or
that a selected subset of domains is different from each subset in one or more consecutive, previously selected subsets until each of the plurality of domains has been included at least once in the one or more consecutive, previously selected subsets; and
transmitting a first indication of the first subset of domains in an information element in a beacon frame.

12. The method of claim 11, wherein the information element is a fast initial link setup indication information element (FILS indication IE).

13. The method of claim 11, wherein the predetermined rule further defines that the selected subset of domains that is different from each subset of one or more consecutive, previously selected subsets is selected from the plurality of domains in a round robin manner.

14. The method of claim 11, wherein the information element carries indications of a maximum number of M domains, M being a positive integer, and wherein the plurality of domains includes more than M domains.

15. The method of claim 14, wherein the predetermined rule further defines that the first subset of domains that is selected in accordance with the usage of each of the first subset of domains includes M most used domains.

16. The method of claim 11, wherein an indication of each given domain of the plurality of domains is a hash of a name of the given domain or a full name of the given domain.

17. An apparatus for wireless communication, the apparatus being a station, comprising:
a memory; and
at least one processor coupled to the memory and configured to:
receive a first beacon frame from an access point, wherein the first beacon frame includes a first indication of a first set of domains that are supported by the access point;
determine that the station has not established credentials with any one domain of the first set of domains; and
perform at least one of
(a) receiving a second beacon frame from the access point, wherein the second beacon frame includes a second indication of a second set of domains that are supported by the access point, wherein the first set of domains is different from the second set of domains; or
(b) sending, to the access point, a probe request frame including a third indication of a third set of domains with which the station has established second credentials.

18. The apparatus of claim 17, wherein the first indication is included in a first fast initial link setup indication information element (FILS indication IE) of the first beacon frame, wherein the second indication is in included in a second FILS indication IE of the second beacon frame, and wherein the third indication is included in a FILS request parameters element of the probe request frame.

19. The apparatus of claim 17, wherein the second beacon frame is received from the access point, and wherein the at least one processor is further configured to:
determine that the station has established third credentials with one or more domains of the second set of domains; and
select the access point for connection.

20. The apparatus of claim 17, wherein the probe request frame is sent to the access point, and wherein the at least one processor is further configured to:
determine whether the access point supports at least a first domain of the third set of domains based on a behavior of the access point; and
select the access point for connection when the access point is determined to support the first domain of the third set of domains.

21. The apparatus of claim 20, wherein the at least one processor is further configured to:
receive a probe response frame;
determine that the behavior of the access point includes sending the probe response frame to the station, wherein the probe response frame includes a fourth indication of a fourth set of domains, wherein the fourth set of domains is a subset of the third set of domains, and wherein the access point is determined to support the first domain of the third set of domains; and
send credentials of the first domain to the access point to establish the connection, wherein the first domain is in the fourth set of domains.

22. The apparatus of claim 21, wherein the fourth set of domains includes at least two domains, and wherein the at least one processor is further configured to:
select the first domain from the fourth set of domains based on a predetermined rule.

23. The apparatus of claim 22, wherein the predetermined rule selects a domain from a plurality of domains randomly or based on a roaming agreement or a pricing agreement.

24. The apparatus of claim 20, wherein the at least one processor is further configured to:
determine that the behavior of the access point includes not sending a probe response frame in response to the probe request frame to the station within a predetermined time period after the probe request frame is sent by the station, wherein the access point is determined to not support any domain of the third set of domains; and
refrain from selecting the access point for the connection.

25. The apparatus of claim 20, wherein the at least one processor is further configured to:
receive a probe response frame;
determine that the behavior of the access point includes sending the probe response frame to the station, wherein the probe response frame includes a fourth indication of a fourth set of domains, wherein the fourth set of domains does not match any domain of the third set of domains, wherein the access point is determined to not support any domain of the third set of domains; and
refrain from selecting the access point for the connection.

26. An apparatus for wireless communication, the apparatus being an access point, comprising:
a memory; and
at least one processor coupled to the memory and configured to:
determine a first subset of domains of a plurality of domains in accordance with a predetermined rule, wherein each of the plurality of domains is associated with a service provider, and wherein the predetermined rule defines:
that the first subset of domains is selected in accordance with a usage of each of the plurality of domains by stations, or
that a selected subset of domains is different from each subset in one or more consecutive, previously selected subsets until each of the plurality of domains has been included at least once in the one or more consecutive, previously selected subsets; and
transmit a first indication of the first subset of domains in an information element in a beacon frame.

27. The apparatus of claim 26, wherein the information element is a fast initial link setup indication information element (FILS indication IE).

28. The apparatus of claim 26, wherein the predetermined rule further defines that the selected subset of domains that is different from each subset of one or more consecutive, previously selected subsets is selected from the plurality of domains in a round robin manner.

29. The apparatus of claim 26, wherein the information element carries indications of a maximum number of M domains, M being a positive integer, and wherein the plurality of domains includes more than M domains.

30. The apparatus of claim 29, wherein the predetermined rule further defines that the first subset of domains that is selected in accordance with the usage of each of the first subset of domains includes M most used domains.
